(19) United States
(12) Patent Application Publication
(10) Pub. No.: US 2024/0314060 A1
(43) Pub. Date: Sep. 19, 2024

(54) MOBILITY ENHANCEMENT FOR INTERCONNECTED ETHERNET VIRTUAL PRIVATE NETWORKS

(71) Applicant: Cisco Technology, Inc., San Jose, CA (US)

(72) Inventors: Krishnaswamy Ananthamurthy, Leander, TX (US); Lukas Krattiger, Pleasanton, CA (US); Ali Sajassi, Alamo, CA (US)

(21) Appl. No.: 18/324,574

(22) Filed: May 26, 2023

Related U.S. Application Data
(60) Provisional application No. 63/489,922, filed on Mar. 13, 2023.

(51) Int. Cl. H04L 45/021; H04L 45/00; H04L 45/586

(52) U.S. Cl. CPC H04L 45/021; H04L 45/586; H04L 45/66

(57) ABSTRACT

A method includes creating a first routing table at each of a plurality of provider edge nodes in a first data center, the first routing table including a first sequence number tracking intra-data center movement of the host connected to one of the plurality of provider edge nodes; creating a second routing table at a corresponding gateway of each of a plurality of data centers, the plurality of data centers including the first data center, the second routing table including the first sequence number for the host and a second sequence number for tracking inter-data center movement of the host between the plurality of data centers host; and updating one of (1) the first sequence number when the host makes an intra-data center move, or (2) the second sequence number in the second routing table when the host makes an inter-data center move.

### RELATED APPLICATION DATA

This application claims priority to U.S. Provisional Application No. 63/489,922 filed on Mar. 13, 2023, the entire content of which is incorporated herein by reference.

### TECHNICAL FIELD

The present disclosure relates to communication systems, and in particular, to enhancing mobility management of endpoints connected to edge nodes in interconnected Ethernet Virtual Private Networks (EVPNs) environment, as endpoints undertake intra-network and inter-network mobility.

### BACKGROUND

Unknown Unicast Media Access Control (MAC) Route (UMR) is defined in RFC 7543 by Internet Engineering Task Force (IETF) and usage thereof is defined in RFC 9014. According to UMR, a Data Center (DC) Interconnect (DCI) or DC Gateways (GWs) may advertise a MAC/IP address of a given host into a given DC. UMR is a regular EVPN MAC/IP advertisement route in which the MAC Address Length is set to 48, the MAC address is set to 0, and the Ethernet Segment Identifier (ESI) field is set to the DC GW's I-ESI. A Network Virtualization Edge (NVE) within that DC that understands and processes the UMR can send unknown unicast frames to one of the DC's GWs, which will then forward that packet to the correct egress Provider Edge (PE). Through UMR, DCI can suppress advertisement of more specific routes towards the given DC and UMR can act as the default MAC route for unknown MAC address within the DC. Therefore, MAC address tables on local DC PEs may only have MAC addresses of connected endpoints within the local DC. MAC addresses outside the local DC can make use of UMR to send unknown MAC Address packets to endpoints in other interconnected data centers.

Current mobility procedures for EVPNs, as described above, can break an endpoint's mobility if the endpoint moves from one data center to another.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates an example of a high-level network architecture in accordance with some aspects of the present technology;

FIG. 2 illustrates an example network environment of interconnected EVPNs according to some aspects of the present disclosure;

FIG. 3 illustrates an example of host mobility in a network environment of interconnected EVPNs according to some aspects of the present disclosure;

FIG. 4 illustrates an example of host mobility in a network environment of interconnected EVPNs according to some aspects of the present disclosure;

FIG. 5 illustrates an example flow chart of an enhanced mobility management procedure in an interconnected network environment according to some aspects of the present disclosure;

FIG. 6 illustrates an example flow chart of a process for determining which one of the first and second sequence numbers to update upon detecting an intra-DC and/or inter-DC movement of a host according to some aspects of the present disclosure; and

FIG. 7 shows an example of computing system according to some aspects of the present disclosure.

### DESCRIPTION OF EXAMPLE EMBODIMENTS

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be references to the same embodiment or any embodiment; and, such references mean at least one of the embodiments.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any example term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

### Overview

The present disclosure provides an enhancement to advertising inter-data center and intra-data center mobility of hosts (endpoints) in a multi-data center (multi-EVPN) network environment. As will be described in greater detail below, two separate counters (sequence numbers) will be used to monitor a host's mobility. The intra-data center mobility counter (intra-data center sequence number) are kept and updated at provider edges within a given data center as well as one or more gateways of the same data center. The intra-data center counter and an inter-data center mobility counter (inter-data center sequence number) are kept and updated at the gateways of all the interconnected data centers (and/or a DCI). The disclosed mobility management mechanism is applicable to both UMR advertisement and also to other route advertisement mechanism for interconnected networks.

In one aspect, a method includes creating a first routing table at each of a plurality of provider edge nodes in a first data center, the first routing table including a first sequence number for a host connected to one of the plurality of provider edge nodes, the first sequence number being used to track intra-data center movement of the host within the first data center. The method further includes creating a second routing table at a corresponding gateway of each of a plurality of data centers, the plurality of data centers including the first data center, the second routing table including the first sequence number for the host and a second sequence number for the host, the second sequence number being used to track inter-data center movement of the host between the plurality of data centers. The method further includes updating one of (1) the first sequence number in the first routing table when the host makes an intra-data center move from a first provider edge node to a second provider edge node in the first data center, or (2) the second sequence number in the second routing table when the host makes an inter-data center move from the first data center to a second data center of the plurality of data centers.

In another aspect, the method further includes receiving an indication of the intra-data center movement of the host when a second provider edge node in the first data center advertises a Media Access Control (MAC) address of the host.

In another aspect, the method further includes updating the first sequence number in the second routing table at the corresponding gateway of the second data center.

In another aspect, the method further includes receiving an indication of the inter-data center movement of the host when the corresponding gateway of the second data center receives a Media Access Control (MAC) address of the host from a provide edge node in the second data center.

In another aspect, the method further includes updating the second sequence number in the second routing table at the corresponding gateway of the second data center, and advertising the MAC address of the host to the corresponding gateway of remaining data centers of the plurality of data centers.

In another aspect, the method further includes removing, from the second routing table at the corresponding gateway of the first data center, previously advertised MAC address of the host, and incrementing, at the corresponding gateway of the first data center, the first sequence number for the host.

In another aspect, the corresponding gateway of the first data center advertises a message to the plurality of provider edge nodes in the first data center, the message including the first sequence number incremented and an Unknown MAC Route (UMR) flag set to one, and each of the plurality of provider edge nodes in the first data center delete the MAC address of the host from a respective local MAC-Virtual Routing and Forwarding (VRF) table.

In one aspect, a network controller includes one or more memories having computer-readable instructions stored therein, and one or more processors. The one or more processors are configured to execute the computer-readable instructions to (a) create a first routing table at each of a plurality of provider edge nodes in a first data center, the first routing table including a first sequence number for a host connected to one of the plurality of provider edge nodes, the first sequence number being used to track intra-data center movement of the host within the first data center, (b) create a second routing table at a corresponding gateway of each of a plurality of data centers, the plurality of data centers including the first data center, the second routing table including the first sequence number for the host and a second sequence number for the host, the second sequence number being used to track inter-data center movement of the host between the plurality of data centers and (c) update one of (1) the first sequence number in the first routing table when the host makes an intra-data center move from a first provider edge node to a second provider edge node in the first data center, or (2) the second sequence number in the second routing table when the host makes an inter-data center move from the first data center to a second data center of the plurality of data centers.

In one aspect, one or more non-transitory computer-readable media include computer-readable instructions, which when executed by one or more processors of a network controller of an interconnected network, cause the network controller to (a) create a first routing table at each of a plurality of provider edge nodes in a first data center, the first routing table including a first sequence number for a host connected to one of the plurality of provider edge nodes, the first sequence number being used to track intra-data center movement of the host within the first data center, (b) create a second routing table at a corresponding gateway of each of a plurality of data centers, the plurality of data centers including the first data center, the second routing table including the first sequence number for the host and a second sequence number for the host, the second sequence number being used to track inter-data center movement of the host between the plurality of data centers and (c) update one of (1) the first sequence number in the first routing table when the host makes an intra-data center move from a first provider edge node to a second provider edge node in the first data center, or (2) the second sequence number in the second routing table when the host makes an inter-data center move from the first data center to a second data center of the plurality of data centers.

### EXAMPLE EMBODIMENTS

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims or can be learned by the practice of the principles set forth herein.

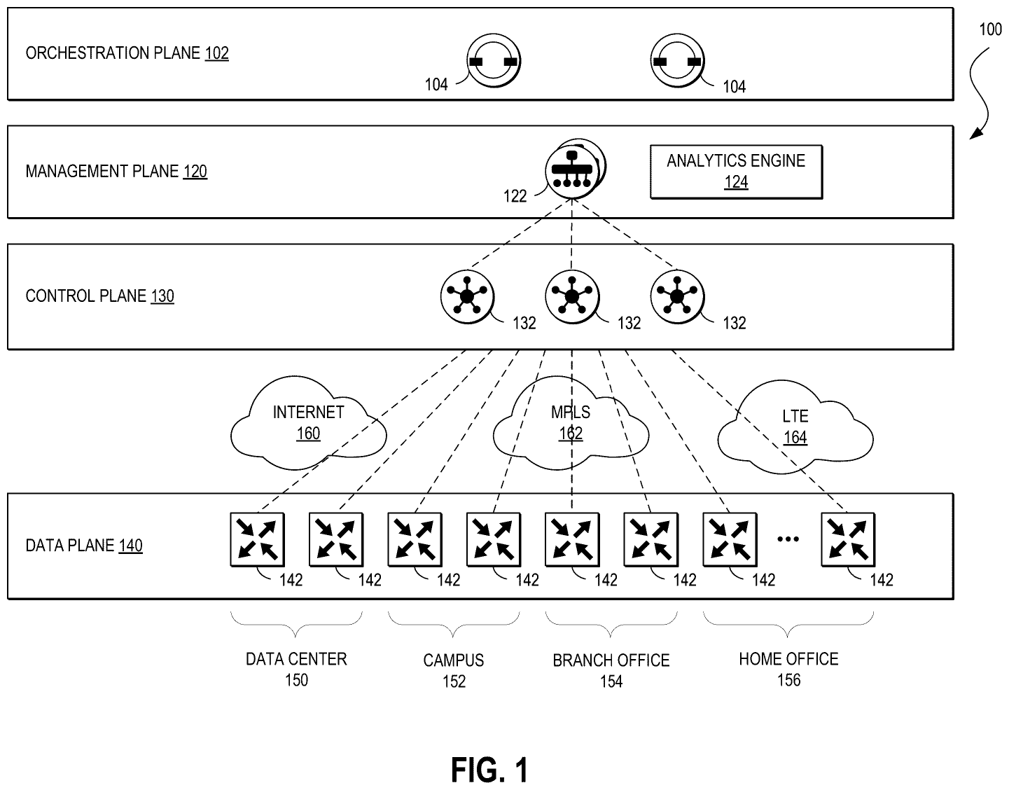

FIG. 1 illustrates an example of a network architecture 100 for implementing aspects of the present technology. An example of an implementation of the network architecture 100 is the Cisco® SD-WAN architecture. However, one of ordinary skill in the art will understand that, for the network architecture 100 and any other system discussed in the present disclosure, there can be additional or fewer components in similar or alternative configurations. The illustrations and examples provided in the present disclosure are for conciseness and clarity. Other embodiments may include different numbers and/or types of elements but one of ordinary skill the art will appreciate that such variations do not depart from the scope of the present disclosure.

In this example, the network architecture 100 can comprise an orchestration plane 102, a management plane 120, a control plane 130, and a data plane 140. The orchestration plane can 102 assist in the automatic on-boarding of edge network devices 142 (e.g., switches, routers, etc.) in an overlay network. The orchestration plane 102 can include one or more physical or virtual network orchestrator appliances 104. The network orchestrator appliance(s) 104 can perform the initial authentication of the edge network devices 142 and orchestrate connectivity between devices of the control plane 130 and the data plane 140. In some embodiments, the network orchestrator appliance(s) 104 can also enable communication of devices located behind Network Address Translation (NAT). In some embodiments, physical or virtual Cisco® SD-WAN vBond appliances can operate as the network orchestrator appliance(s) 104.

The management plane 120 can be responsible for the central configuration and monitoring of a network. The management plane 120 can include one or more physical or virtual network management appliances 122, an analytics engine 124, etc. In some embodiments, the network management appliance(s) 122 can provide centralized management of the network via a graphical user interface to enable a user to monitor, configure, and maintain the edge network devices 142 and links (e.g., Internet transport network 160, Multiprotocol Label Switching (MPLS) network 162, 4G/LTE network 164) in an underlay and overlay network. The network management appliance(s) 122 can support multi-tenancy and enable centralized management of logically isolated networks associated with different entities (e.g., enterprises, divisions within enterprises, groups within divisions, etc.). Alternatively or in addition, the network management appliance(s) 122 can be a dedicated network management system for a single entity. In some embodiments, physical or virtual Cisco® SD-WAN vManage appliances can operate as the network management appliance(s) 122.

The control plane 130 can build and maintain a network topology and make decisions on where traffic flows. The control plane 130 can include one or more physical or virtual network controller appliance(s) 132. The network controller appliance(s) 132 can establish secure connections to each edge network device 142 and distribute route and policy information via a control plane protocol (e.g., Overlay Management Protocol (OMP) (discussed in further detail below), Open Shortest Path First (OSPF), Intermediate System to Intermediate System (IS-IS), Border Gateway Protocol (BGP), Protocol-Independent Multicast (PIM), Internet Group Management Protocol (IGMP), Internet Control Message Protocol (ICMP), Address Resolution Protocol (ARP), Bidirectional Forwarding Detection (BFD), Link Aggregation Control Protocol (LACP), etc.). In some embodiments, the network controller appliance(s) 132 can operate as route reflectors. The network controller appliance(s) 132 can also orchestrate secure connectivity in the data plane 140 between and among the edge network devices 142. For example, in some embodiments, the network controller appliance(s) 132 can distribute crypto key information among the network device(s) 142. This can allow the network to support a secure network protocol or application (e.g., Internet Protocol Security (IPSec), Transport Layer Security (TLS), Secure Shell (SSH), etc.) without Internet Key Exchange (IKE) and enable scalability of the network. In some embodiments, physical or virtual Cisco® SD-WAN vSmart controllers can operate as the network controller appliance(s) 132.

The data plane 140 can be responsible for forwarding packets based on decisions from the control plane 130. The data plane 140 can include the edge network devices 142, which can be physical or virtual network devices. The edge network devices 142 can operate at the edges various network environments of an organization, such as in one or more data centers or colocation centers 150, campus networks 152, branch office networks 154, home office networks 156, and so forth, or in the cloud (e.g., Infrastructure as a Service (IaaS), Platform as a Service (PaaS), SaaS, and other cloud service provider networks). The edge network devices 142 can provide secure data plane connectivity among sites over one or more WAN transports, such as via one or more Internet transport networks 160 (e.g., Digital Subscriber Line (DSL), cable, etc.), MPLS networks 162 (or other private packet-switched network (e.g., Metro Ethernet, Frame Relay, Asynchronous Transfer Mode (ATM), etc.), mobile networks 164 (e.g., 3G, 4G/LTE, 5G, etc.), or other WAN technology (e.g., Synchronous Optical Networking (SONET), Synchronous Digital Hierarchy (SDH), Dense Wavelength Division Multiplexing (DWDM), or other fiber-optic technology; leased lines (e.g., T1/E1, T3/E3, etc.); Public Switched Telephone Network (PSTN), Integrated Services Digital Network (ISDN), or other private circuit-switched network; small aperture terminal (VSAT) or other satellite network; etc.). The edge network devices 142 can be responsible for traffic forwarding, security, encryption, quality of service (QOS), and routing (e.g., BGP, OSPF, etc.), among other tasks. In some embodiments, physical or virtual Cisco® SD-WAN vEdge routers can operate as the edge network devices 142.

EVPN (Ethernet Virtual Private Network) is a technology for building virtual private networks (VPNs) using Ethernet Virtual Connections (EVCs) instead of traditional Layer 3 IP VPNs. It allows service providers to offer a wide range of Layer 2 and Layer 3 VPN services to customers over a common infrastructure, using Multiprotocol Label Switching (MPLS) or Virtual Extensible LAN (VXLAN) as the underlying transport technology.

EVPN allows for the creation of a single Layer 2 or Layer 3 VPN domain that can span multiple sites, such as data centers or remote offices. This allows for the creation of a virtual LAN (VLAN) or virtual private wire service (VPWS) that can connect multiple sites together as if they were on the same physical LAN.

EVPN also supports several advanced features such as Virtual Private LAN Service (VPLS), which allows for the creation of a full mesh of Layer 2 VPN connections between multiple sites, and Any-to-Any communication within the VPN. Additionally, EVPN also supports BGP-based auto-discovery and signaling, which simplifies the configuration and management of VPNs.

EVPN is a powerful technology that offers many benefits over traditional IP VPNs. It allows for more efficient use of network resources, better scalability, and more advanced features such as VPLS and Any-to-Any communication. It is an ideal solution for service providers looking to offer advanced VPN services to their customers, as well as for enterprise customers looking to connect multiple sites together over a virtual private network.

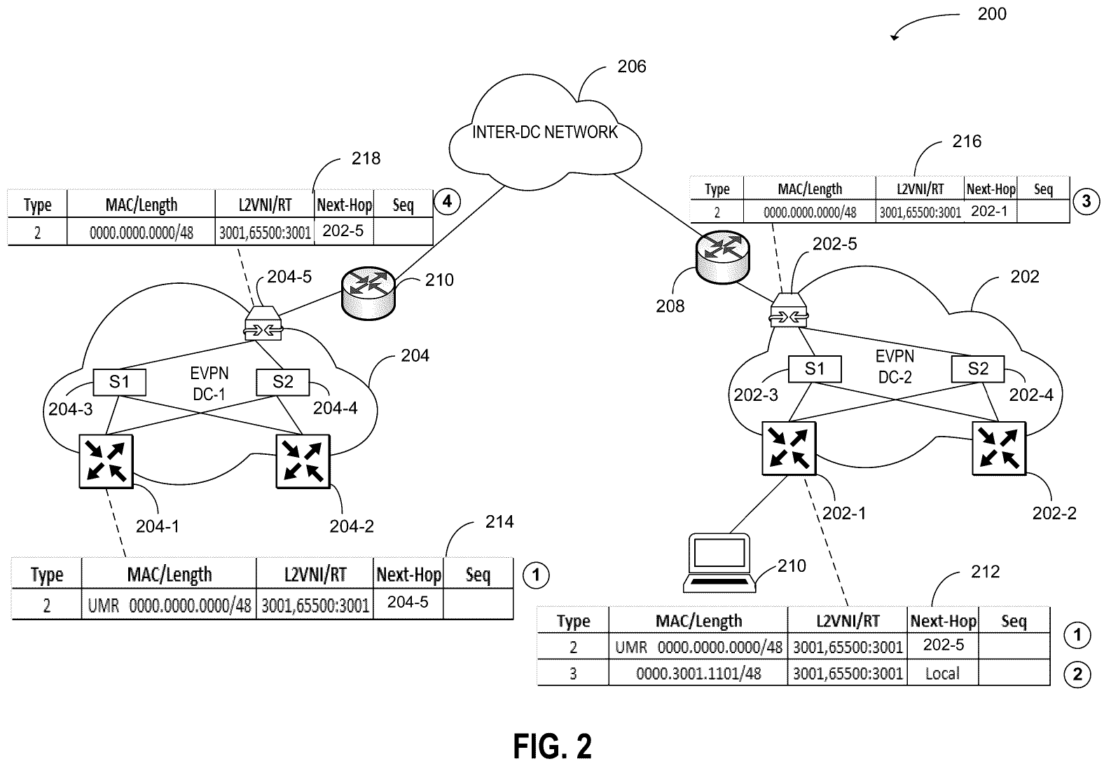

FIG. 2 illustrates an example network environment of interconnected EVPNs according to some aspects of the present disclosure. In example network environment 200, two separate EVPNs (Data Centers (DCs)) 202 and 204 may be connected via an external network such as inter-DC network 206. Each of DCs 202 and 204 may correspond to a different SD-WAN, such as the non-limiting example of SD-WAN of FIG. 1, with independent operations. Alternatively, DCs 202 and 204 may belong to the same SD-WAN network. DCs 202 and 204 may also be referred to as disaggregated EVPN domains 202 and 204. As noted above, each of DCs 202 and 204 may be Virtual Extensible LAN (VXLAN) EVPNs that deploy various fabric technologies (e.g., Internet Protocol-Border Gateway Protocol (“IP-BGP”), BGP, EVPN, FabricPath using BGP Layer 3 Virtual Private Network (“L3EVPN”), MPLS fabric, etc.) for traffic routing. VXLAN is an overlay technology for network virtualization that provides Layer 2 extension over a Layer 3 underlay infrastructure network by using MAC addresses in Internet Protocol/User Datagram Protocol (IP/UDP) tunneling encapsulation. According to a further example, inter-DC network 206 may be a Layer 2/3 Data Center Interconnect (“DCI”) network.

To facilitate the routing of network traffic through Autonomous Systems (e.g., DCs 202 and 204), or more specifically, network devices and components within the ASes, the network devices may exchange routing information to various network destinations. BGP is conventionally used to exchange routing and reachability information among network devices within a single AS or between different ASes. The BGP logic of a router is used by the data collectors to collect BGP AS path information, e.g., the “AS_PATH” attribute from BGP tables of border routers (e.g., routers 208 and 209) of an AS, to construct paths to prefixes.

To exchange BGP routing information, two BGP hosts (e.g., GWs 202-5 and 204-5), or peers, first establish a transport protocol connection with one another. Initially, the BGP peers exchange messages to open a BGP session, and, after the BGP session is open, the BGP peers exchange their entire routing information. Thereafter, under some circumstances, only updates or changes to the routing information, e.g., the “BGP UPDATE” attribute, are exchanged, or advertised, between the BGP peers. The exchanged routing information is maintained by the BGP peers during the existence of the BGP session.

DC 202 may include, among other known or to be developed components, components such as wireless access points, routers, gateways, switches, etc. Examples of such components include a number of provider edges (PEs) such as PEs 202-1 and 202-2. PEs 202-1 and 202-4 may be the same as edge network devices 142 of FIG. 1. DC 202 may further include one or more spine nodes such as S1 202-3 and S2 202-4, which may be in communication with one or more leaf nodes such as PEs 202-1 and 202-2. DC 202 also includes a DC gateway (GW) 202-5 for network traffic routing to other DCs such as DC 204. The number of components of DC 202 are not limited to those shown in FIG. 2 and may be more or less.

Similar to DC 202, DC 204 may include, among other known or to be developed components, components such as wireless access points, routers, gateways, switches, etc. Examples of such components include a number of provider edges (PEs) such as PEs 204-1 and 204-2. PEs 204-1 and 204-4 may be the same as edge network devices 142 of FIG. 1. DC 204 may further include one or more spine nodes such as S1 204-3 and S2 204-4, which may be in communication with one or more leaf nodes such as PEs 204-1 and 204-2. DC 204 also includes a DC gateway (GW) 204-5 for network traffic routing to other DCs such as DC 202. The number of components of DC 204 are not limited to those shown in FIG. 2 and may be more or less.

Router 208 may be configured to enable communication of network traffic flows between DC 202 and inter-DC network 206. Similarly, router 209 may be configured to enable communication of network traffic flows between DC 204 and inter-DC network 206. Each of routers 208 and 209 is configured to route network traffic flows received from the respective one of GWs 202-5 and 204-5.

A host device 210 may be connected to any one of PEs 202-1, 202-2, 204-1, and/or 204-2. In the non-limiting example of FIG. 2, host 210 is connected to PE 202-1. Host 210 may also be referred to as endpoint 210 and may be any device capable of attaching to a network (wired and/or wireless). Examples of host 210 include, but are not limited to, a laptop, a mobile device, a desktop, a tablet, a printer, a phone, an Internet of Things (IoT) device, etc.

At any given point in time, each of PEs 202-1, 202-2, 204-1, and 204-2 as well as GWs 202-5 and 204-5 may have an associated routing table for keeping track of mobility of hosts and using the same for proper routing of network traffic to any given host such as host 210.

As a non-limiting example, FIG. 2 illustrates routing table 212 for PE 202-1, routing table 214 for PE 204-1, routing table 216 for GW 202-5 and routing table 218 for GW 204-5.

In example of FIG. 2, host 210 is attached to (connected to) PE 202-1. In the context of UMR routing, at \textcircled{1}, GWs 204-5 and 202-5 advertise UMR route to their respective PEs (i.e., GW 202-5 advertises UMR to PEs 202-1 and 202-2 while GW 204-5 advertises UMR to PEs 204-1 and 204-2). This is reflected in tables 212 and 214.

At \textcircled{2}, PE 202-1 learns that host 210 is a local attachment when host 210 connects to PE 202-1. This is reflected on the second row entry of table 312.

At \textcircled{3}, GW 202-5 receives, from PE 202-1, the MAC/IP address of host 210. This is reflected in table 316.

At \textcircled{4}, GW 204-5 receives the MAC/IP address of host 210 via GW 202-5. This is reflected in table 318.

Given the UMR procedure, GW 204-5 will suppress the advertisement of the MAC/IP address of host 210 to its local PEs 204-1 and 204-2 as it has already advertised UMR route. Accordingly, PE 204-1 (and similarly PE 204-2) forwards any packet received for host 210 to GW 204-5 to be then forward to host 210 via GW 202-5 in DC 202.

EVPN host mobility procedures make use of the sequence number defined in “MAC Mobility Extended Community” in which a higher sequence number will determine the correct attachment of a host to a PE. With UMR, DCI (or GWs 202-5 and 204-5) suppress the more specific MAC address advertisement to DC PEs. This is noted in step @ above. Therefore, if host 210 moves from DC 202 to DC 204, then the new local PE (e.g., PE 204-1) to which host 210 is newly attached, generates the MAC/IP route with an incremented sequence number because it doesn't have the MAC/IP route of host 210 learned remotely. This will break the host mobility if the host moves from a different DC to a local DC-PE. The current RFC by IETF that defines the mobility procedure for UMR does not cover this movement and how to properly manage it.

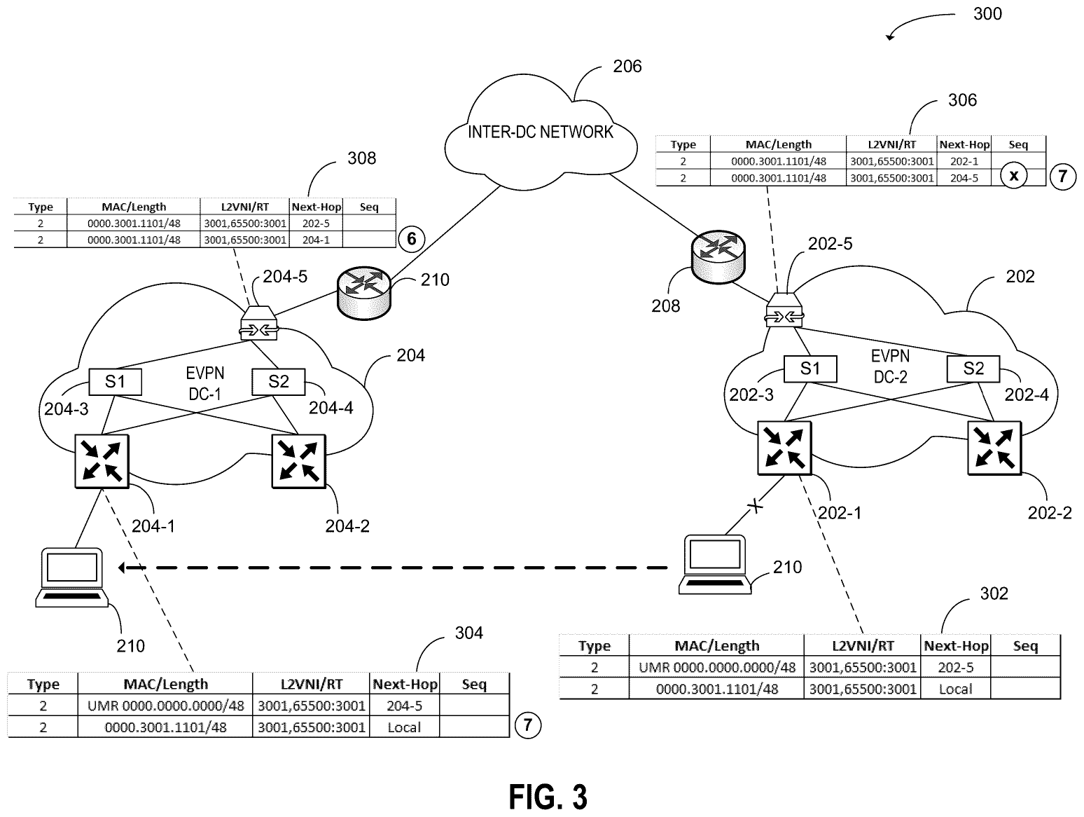

FIG. 3 illustrates an example of host mobility in a network environment of interconnected EVPNs according to some aspects of the present disclosure.

Structure of example network environment 300 of FIG. 3 is the same as that of FIG. 2 except that host 210 has now moved from PE 202-1 in DC 202 and attached to PE 204-1 in DC 204. In other words, host 210 has made an inter-DC movement. Furthermore and as will be described below, routing tables of each of PEs 202-1, 204-1, GW 202-5 and GW 204-5 arc updated based on host 210's inter-DC movement. Otherwise, all other components an elements of FIG. 3 remain the same as that described with reference to FIG. 2 and hence will not be further described for sake of brevity.

Upon movement of host 210 from PE 202-1 in DC 202 to PE 204-1 in DC 204, at \textcircled{5}, routing table 304 of PE 204-1 is updated to add a local attachment entry for host 210 (in addition to the previous routing table 214 of FIG. 2).

At \textcircled{6}, routing table 308 of GW 204-5 is updated with two possible paths for host 210. One path is via PE 204-1 and the other is the previous path via GW 202-5 (as reflected in routing table 218 of FIG. 2). Both paths have no sequence number associated therewith and BGP As-Path length may influence the best path to be chosen as the path from PE 204-1 and advertised to other DCs such as DC 202.

At \textcircled{7}, GW 202-5 receives the path information for host 210 from GW 204-5. At this point and as reflected in table 306, GW 202-5 has two paths for host 210 recorded therein. One is the previous route via PE 202-1 (when host 210 was attached to PE 2021) and the new path via GW 204-5 as received from GW 204-5. Because there is no sequence number for the two possible paths via PE 202-1 and GW 204-5, BGP AS-length may be used determine the best path. This determination may result in the best path to host 210 being via PE 202-1, which is incorrect. This determination results in local PEs in DC 202 (e.g., PE 202-2) forwarding traffic for host 210, to PE 202-1 as PE 202-2 is not aware that host 210 has moved to PE 204-1 in DC 204 (PE 202-2 is not aware of host 210's movement because GW 202-5 has incorrectly determined the best path for host 210 to be via PE 202-1). Table 302 remains the same as table 212 of FIG. 2 described above.

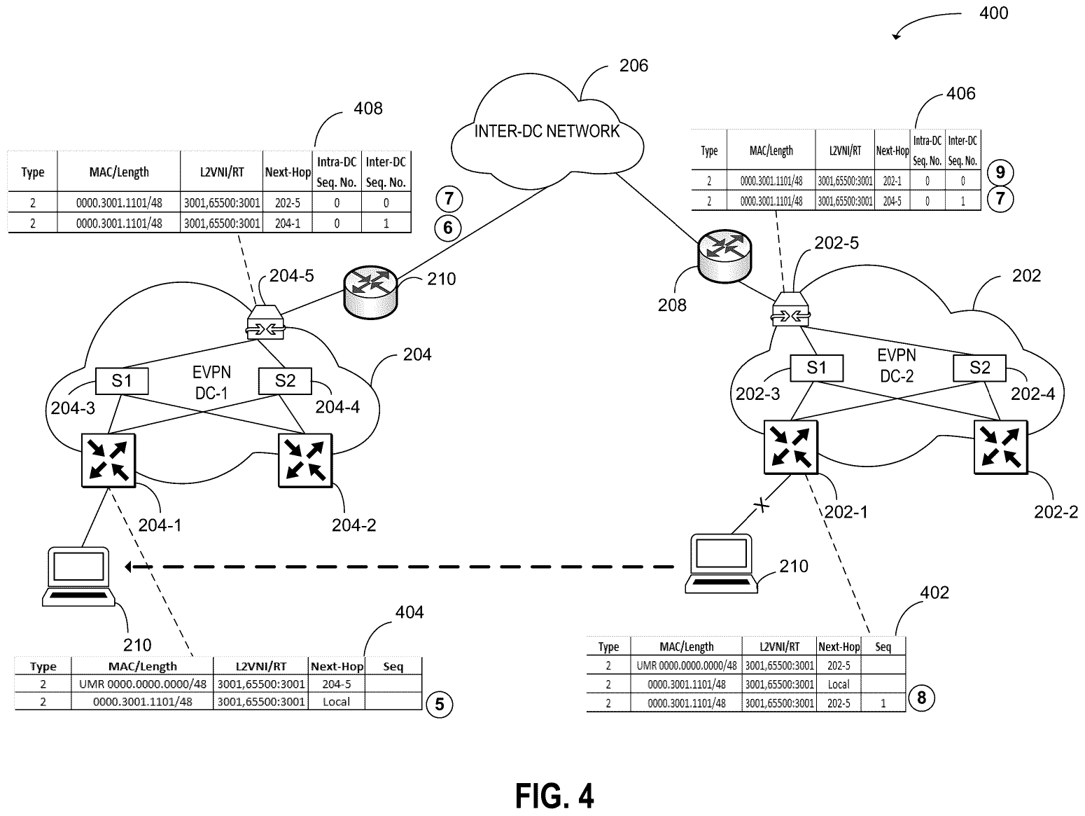

FIG. 4 illustrates an example of host mobility in a network environment of interconnected EVPNs according to some aspects of the present disclosure.

Similar to FIG. 3, structure of example network environment of FIG. 4 is the same as that of FIG. 2 except that host 210 has now moved from PE 202-1 in DC 202 and attached to PE 204-1 in DC 204. In other words, host 210 has made an inter-DC movement. However, in contrast to FIG. 3, upon mobility of host 210 from one PE to another, routing tables of each of PEs 202-1, 204-1, GW 202-5 and GW 204-5 are updated based on the proposed host mobility management protocol of the present disclosure using intra-data center and inter-data center sequence numbers, which will be described further below. Otherwise, all other components an elements of FIG. 3 remain the same as that described with reference to FIG. 2 and hence will not be further described for sake of brevity.

As noted above, RFC 7432 describes host/MAC mobility procedures in section 15. When considering host mobility in the context of DC-GWs and unknown EVPN-MAC address route (i.e., UMR), the following three uses cases need to be considered. First, PEs in a given DC such as DC 202 maintain all MAC/IP addresses in DC 202 but not for remote DCs (e.g., DC 204) for the interested EVPN Virtual Instance (EVIs). An EVI is formed based on interconnected of multiple DCs. For instance, interconnection of DCs 202 and 204 via a DCI (e.g., inter-DC network 206) is an example of an EVI. Second, A PE in a given DC (e.g., PE 202-1 in DC 202) only maintains MAC/IP addresses for locally connected hosts but not for remote MAC/IP addresses of that DC for the interested EVIs. Third, a multi-tier hierarchical architecture where a DC-GW does not maintain all MAC/IP addresses across all DCs for the interested EVIs (i.e., a DC-GW can be a spine connected to a set of super spines where spines maintain MAC/IP addresses for their own DCs for the interested EVIs but only super spines maintain MAC/IP addresses across all DCs for the interested EVIs).

Since the advertisement of MAC/IP addresses from remote data centers are not propagated all the way to the DC-PE of the local data center, the MAC mobility procedures of RFC 7432 cannot be used as is. A modification to this mobility procedure is proposed herein. According to this modification, two independent sets of MAC mobility sequence numbers are introduced, maintained, and updated. One MAC mobility sequence number is associated with intra-DC movement of hosts (may be referred to as intra-de sequence number/counter or simply a first sequence number. The other MAC mobility sequence number is associated with inter-DC movement of hosts (may be referred to as inter-de sequence number/counter or simply a second sequence number). When the host mobility is confined to a DC (i.e., intra-DC host mobility), then only the intra-DC sequence number is incremented upon a host's move from one PE in a given DC to another PE in the same DC, without any changes to inter-DC sequence number. When the host moves from one DC to another, then the inter-DC sequence number is incremented. FIG. 4 illustrates details of an example procedure for maintaining the inter-DC and intra-DC sequence numbers.

In example network structure 400 of FIG. 4, upon host 210 moving from PE 202-1 in DC 202 to PE 204-1 in DC 204, step \textcircled{5} described above with reference to FIG. 3 remains the same (i.e., routing table 404 is the same as routing table 304 of FIG. 3).

In comparison to step \textcircled{6} described with reference to FIG. 3, under the proposed modification, at step \textcircled{6}, GW 204-5 maintains both the inter-DC sequence number and the intra-DC sequence number. GW 204-5 advertises inter-DC sequence number to other DCs (e.g., DC 202) while inter-DC sequence number is advertised to local PEs (e.g., PE 204-1 and PE 204-2).

In this instance, GW 204-5 has a remote path for host 210 and detects mobility after receiving the local path for host 210 from PE 204-1. Thereafter, GW 204-5 selects the local path as best path to reach host 210 and increments the inter-DC sequence number to 1, which GW 204-5 then advertises to remote DCs (e.g., DC 202). This is reflected in table 408 of FIG. 4 where inter-DC sequence number is incremented by 1 from 0 to 1.

In comparison to step \textcircled{7} described with reference to FIG. 3, under the proposed modification, at step \textcircled{7}, GW 202-5 has a local path from PE 202-1 and detects mobility after receiving a remote DC path for host 210 with inter-DC sequence number of 1 from GW 204-5. Upon observing the updated inter-DC sequence number, GW 202-5 selects the remote path to host 210 (i.e., via GW 204-5) as the best path and increments the intra-DC sequence number for host 210 by 1 and advertises it to local DC-PEs with a new flag UMR in MAC mobility Seq extended community.

In one example and for fast convergence among all interconnected DCs (e.g., when there are more than a few DCs interconnected), GW 202-5 can send withdrawal of local path earlier advertised towards the remote DCs.

In describing FIG. 3, it was mentioned that PE 202-1 has PE 202-1 as the best path for reaching host 210. However, based on the updated inter-DC sequence number, PE 202-1 now selects the path from the GW 202-5 as the best path to reach host 210 (due to the higher intra-DC sequence number). Furthermore, given the updated UMR flag, PE 202-1 can remove the route to host 210 from routing table 402 and will let the UMR route send host 210 destined packets to GW 202-5 instead of adding host 210 route with next hop as GW 202-5. However, PE 202-1 may continue to keep the route to host 210 in BGP Routing Information Base (RIB).

At step \textcircled{8}, PE 202-1 detects mobility by receiving, from GW 202-5, the route for host 210 with inter-DC sequence number set to 1 and the UMR flag. This is reflected in updated routing table 402. Thereafter, PE 202-1 follows the RFC 7432 mobility procedures and withdraws the local route for host 210 from routing table 402.

At step \textcircled{9} and after receiving the withdrawal from PE 202-1, all PEs in DC 202 (e.g., PE 202-2) and GW 202-5 remove the existing host 210 path from PE 202-1 from their respective routing tables. In one example, GW 202-5 may withdraw the remote route to internal PEs after no local path is present for host 210 such that internal PEs within DC 202 may remove the route from BGP RIB as UMR is already advertised.

While a non-limiting and specific example of an inter-DC movement of a host is used in the context of FIG. 4 to describe the proposed enhancements to mobility procedures, these enhancements can generally be characterized as including the following.

(1) DC-GWs are to maintain both intra-DC and inter-DC sequence numbers. Local PEs in each DC may operate per baseline and established RFCs without any change (i.e., a DC-PE such as PEs 202-1, 202-2, 204-1, and 204-2 may only maintain a single MAC mobility counter per MAC address).

(2) When a host (MAC address) first appears on a PE (e.g., PE 202-1), such PE may advertise the MAC address without MAC Mobility extended community attribute per section 15 of RFC 7432. When the corresponding DC-GW (e.g., GW 202-5) receives this advertisement and can in turn advertise this MAC address without MAC Mobility extended community attribute to other DC-GWs such as GW 204-5.

(3) When a host moves within a DC (e.g., host 210 moving from PE 202-1 to PE 202-2), the intra-DC sequence number is incremented per section 15 of RFC 7432 on both the local PE to which the host is now attached (e.g., PE 202-2) and corresponding DC-GW (e.g., GW 202-5). However, the inter-DC sequence number does not change and no new MAC/IP advertisement route is sent to remote DC-GWs (e.g., GW 204-5).

(4) When the host moves from a local DC to a remote DC (e.g., host 210 moving from PE 202-1 in DC 202 to PE 204-1 in DC 204), then the remote (new) PE (e.g., PE 204-1) that observes this move, advertises the host MAC/IP route of host 210 for the first time without MAC Mobility extended community. When the corresponding remote DC-GW (e.g., GW 204-5) receives this advertisement, GW 204-5 recognizes the MAC move and advertises the MAC/IP route of host 210 after incrementing the inter-DC sequence number by one.

(5) When the (previous) local DC-GW (e.g., GW 202-5) receives this MAC/IP Advertisement route from the new GW 204-5, GW 202-5 detects that there has been a move because the received intra-DC sequence number is greater than the inter-DC sequence number that GW 202-5 currently has for host 210. To expediate convergence among all DC-GWs across the participant data centers, the local DC-GW (e.g., GW 202-5) may withdraw the previously advertised MAC/IP route of host 210 for the inter-DC network. At the same time, the local DC-GW (e.g., GW 202-5) may reflect this MAC move into their local DC (e.g., to local PEs 202-1 and 202-2) by incrementing the intra-DC sequence number by one and advertising this MAC/IP route with the new sequence number and UMR flag set to one in the MAC Mobility extended community.

(6) The local DC-PE (e.g., PE 202-1 and PE 202-2) where the MAC address of host 210 is reachable via internal local DC-PE (from which it has received reachability before move), upon receiving this advertisement from GW 202-5 and seeing the indication of UMR flag being set to one, detects that host 210 has moved to another DC and thus any further forwarding to the MAC address of host 210 is to be done via UMR processing. Therefore, PE 202-1 and 202-2 remove this MAC address from their respective MAC-Virtual Routing and Forwarding (VRF) tables but may continue to keep the MAC address in their respective BGP table.

(7) The local DC-PE where this MAC address was learned locally (e.g., PE 202-1), upon receiving this advertisement and seeing the indication of UMR flag is set to one, determines that host 210 has moved to another DC (e.g., DC 204) and thus any further forwarding to this MAC address is to be performed via UMR processing. Therefore, PE 202-1 may remove this MAC address from PE 202-1's MAC-VRF tables and send a withdrawal for host 210's MAC/IP advertisement to all other PEs in DC 202. All other DC-PEs (e.g., PE 202-2) and the DC-GW (e.g., GW 202-5) with the EVI of interest will receive this withdrawal message and update the MAC entry in their respective MAC-VRFs. After such update, the forwarding for the MAC address of host 210 within DC 202 is performed based on UMR processing (i.e., all DC-PEs in DCs other than DC 204 forward this unknown MAC address to their corresponding DC-GW and the DC-GW forwards this known MAC address to a remote DC-GW (e.g., GW 204-5) and/or corresponding local attachment circuits.

(8) DC-GWs, after removing all local paths for the given MAC address (e.g., MAC address of host 210) and having only remote DC PATH for host 210 via GW 204-5, may send a withdrawal notice to their respective internal DC-PEs so that internal DC-PEs can remove the route for host 210 (e.g., previous local route via PE 202-1) from their respective BGP Tables.

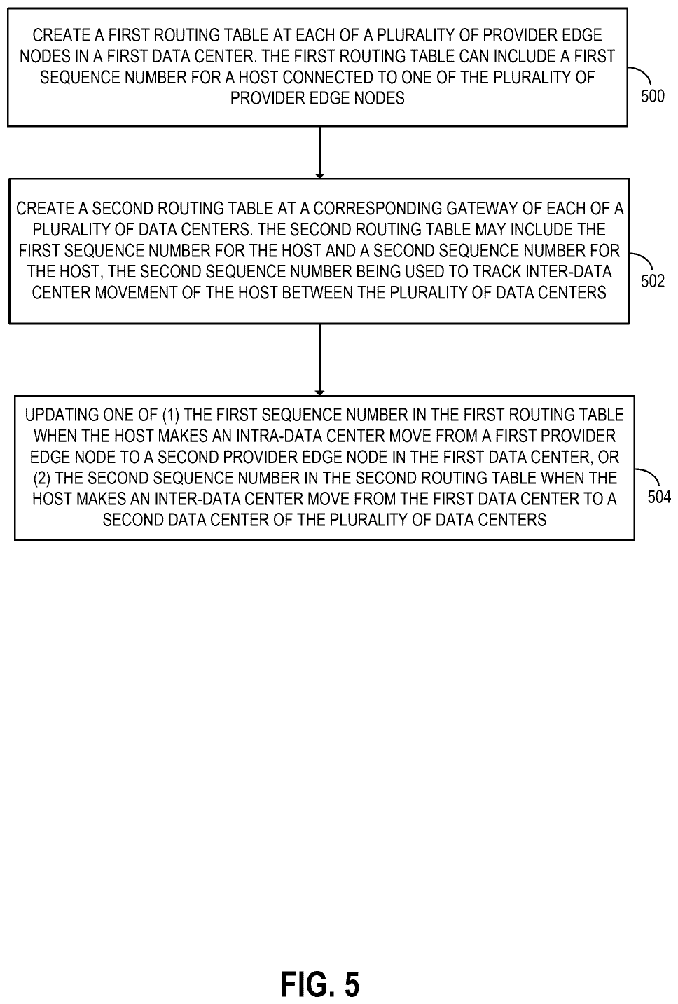

FIG. 5 illustrates an example flow chart of an enhanced mobility management procedure in an interconnected network environment according to some aspects of the present disclosure. The process of FIG. 5 may be performed by a network controller (e.g., a network controller of inter-DC network 206). Such network controller can be the same one of network management appliances 122 or network appliances 132 of FIG. 1. Alternatively, the method of claim 5 can be implemented by a network controller of each of interconnected DCs and/or by each network node (e.g., GWs 202-5, 204-5, PEs 202-1, 202-2, 204-1, 204-2, etc.).

At step 500, a first routing table may be generated (created) at each of a plurality of provider edge nodes in a first data center (e.g., at each of PEs 202-1, 202-2 in DC 202 and/or PEs 204-1 and 204-2 in DC 204). The first routing table can include a first sequence number for a host (e.g., host 210) connected to one of the plurality of provider edge nodes. Routing tables 212, 214, 302, 304, 402, and 404 are non-limiting examples of such first routing tables. The first sequence number being used to track intra-data center movement of the host within the first data center. The first sequence number may be the same as intra-DC sequence number described above.

At step 502, a second routing table may be generated (created) at a corresponding gateway of each of a plurality of data centers (e.g., GW 202-5 of DC 202 and GW 204-5 of DC 204). The plurality of data centers include the first data center of step 500. The second routing table may include the first sequence number for the host and a second sequence number for the host, the second sequence number being used to track inter-data center movement of the host between the plurality of data centers. Routing tables 216, 218, 306, 308, 406, and 408 are non-limiting examples of such second routing tables. The second sequence number may be the same as inter-DC sequence number described above.

At step 504, one or more of the following updates may occur. More specifically, the first sequence number in a first routing table may be updated when host 210 makes an intra-data center move from a first provider edge node to a second provider edge node in the first data center (e.g., from PE 202-1 to PE 202-2 in DC 202). In addition (or alternatively, the second sequence number in the second routing table may be updated when host 210 makes an inter-data center move from the first data center (e.g., from PE 202-1 in DC 202) to a second data center of the plurality of data centers (e.g., to PE 204-1 in DC 204), as described above with reference to FIG. 4.

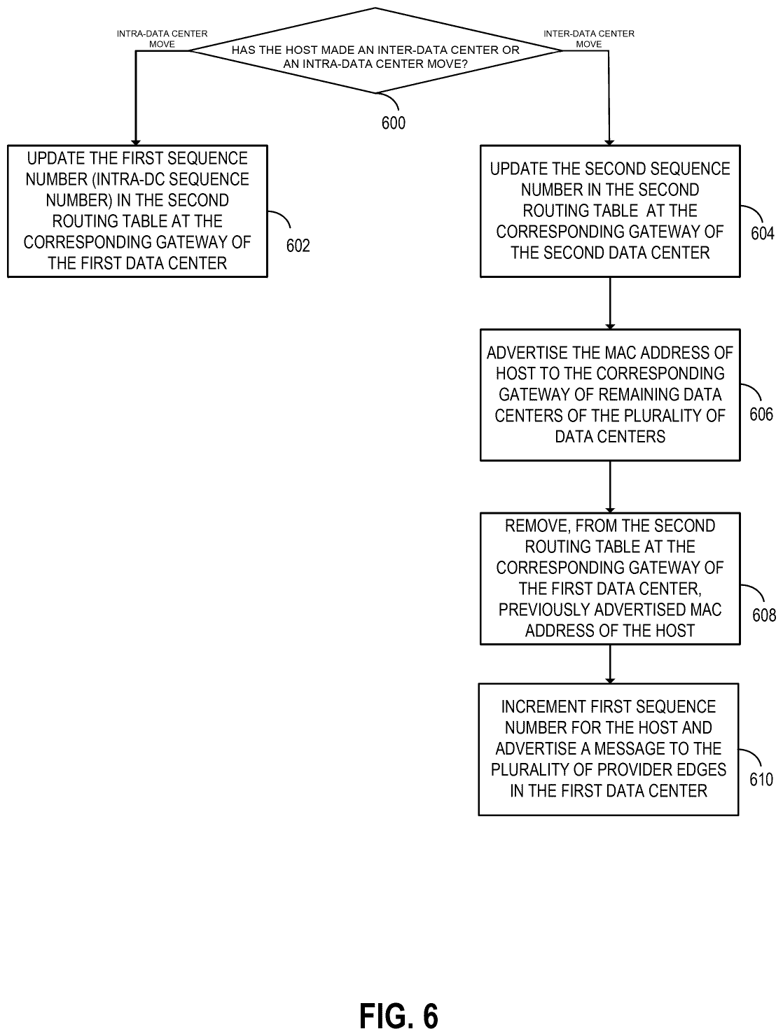

FIG. 6 illustrates an example flow chart of a process for determining which one of the first and second sequence numbers to update upon detecting an intra-DC and/or inter-DC movement of a host according to some aspects of the present disclosure. In one example, FIG. 6 describes the details of the process performed at step 504 of FIG. 5.

At step 600, a determination is made as to whether a host has made an intra-DC movement or an inter-DC movement. In one example, an intra-DC movement is detected when a second provider edge node (e.g., PE 202-2) in the first data center (e.g., DC 202) advertises a Media Access Control (MAC) address of host 210 (host 210 is assumed to have already been attached to PE 202-1 in DC 202).

In another example, an inter-DC movement is detected when the corresponding gateway of the second data center (e.g., GW 204-5) receives a Media Access Control (MAC) address of host 210 from a provide edge node in the second data center (e.g., from PE 204-1 after host 210 moves from PE 202-1 in DC 202 and attaches to PE 204-1 in DC 204).

At step 602 and upon detecting an intra-DC movement of host 210 (e.g., from PE 202-1 to PE 202-2), the first sequence number (intra-DC sequence number) in the second routing table (e.g., table 406) at the corresponding gateway of the first data center (e.g., GW 202-5 of DC 202) is updated (e.g., incremented by 1).

At step 604 and upon detecting an inter-DC movement of host 210 (e.g., from PE 202-1 in DC 202 to PE 204-1 in DC 204), the second sequence number in the second routing table (e.g., routing table 408) at the corresponding gateway of the second data center (e.g., GW 204-5 of DC 204) is updated (e.g., incremented by 1).

At step 606, GW 204-5 may advertise the MAC address of host 210 to the corresponding gateway of remaining data centers of the plurality of data centers (e.g., GW 202-5 of DC 202).

At step 608, GW 202-5 may remove, from the second routing table (e.g., routing table 406) at the corresponding gateway of the first data center (e.g., GW 202-5 of DC 202), previously advertised MAC address of host 210 via PE 202-1.

At step 610, GW 202-5 may increment the first sequence number for host 210 (increment by 1). Furthermore, GW 202-5 may advertise a message to the plurality of provider edge nodes in the first data center (e.g., PEs 202-1 and 202-2 in DC 202). In one example, the message can include the incremented first sequence number per step 608 and an Unknown MAC Route (UMR) flag set to one. In response, each of the plurality of provider edge nodes in the first data center (e.g., PEs 202-1 and 202-2) may delete the MAC address of host 210 from a respective local MAC-Virtual Routing and Forwarding (VRF) table at each of PEs 202-1 and PE 202-2.

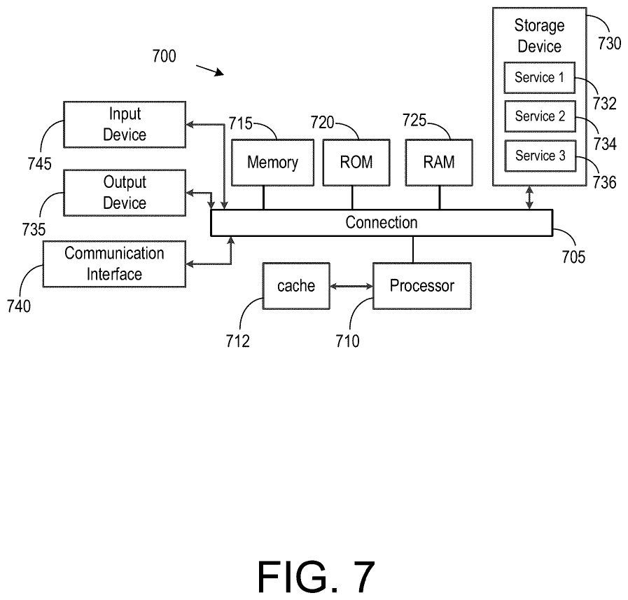

FIG. 7 shows an example of computing system according to some aspects of the present disclosure. As shown, example computing system 700 can be used as any of the components of systems and network architectures described above with reference to FIGS. 1-6. Example computing system 700 or any component thereof in which the components of the system are in communication with each other using connection 705. Connection 705 can be a physical connection via a bus, or a direct connection into processor 710, such as in a chipset architecture. Connection 705 can also be a virtual connection, networked connection, or logical connection.

In some embodiments, computing system 700 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example system 700 includes at least one processing unit (CPU or processor) 710 and connection 705 that couples various system components including system memory 715, such as read-only memory (ROM) 720 and random access memory (RAM) 725 to processor 710. Computing system 700 can include a cache of high-speed memory 712 connected directly with, in close proximity to, or integrated as part of processor 710.

Processor 710 can include any general purpose processor and a hardware service or software service, such as services 732, 734, and 736 stored in storage device 730, configured to control processor 710 as well as a special-purpose processor where software instructions are incorporated into the actual processor design. Processor 710 may essentially be a completely self-contained computing system, containing multiple cores or processors, a bus, memory controller, cache, etc. A multi-core processor may be symmetric or asymmetric.

To enable user interaction, computing system 700 includes an input device 745, which can represent any number of input mechanisms, such as a microphone for speech, a touch-sensitive screen for gesture or graphical input, keyboard, mouse, motion input, speech, etc. Computing system 700 can also include output device 735, which can be one or more of a number of output mechanisms known to those of skill in the art. In some instances, multimodal systems can enable a user to provide multiple types of input/output to communicate with computing system 700. Computing system 700 can include communications interface 740, which can generally govern and manage the user input and system output. There is no restriction on operating on any particular hardware arrangement, and therefore the basic features here may easily be substituted for improved hardware or firmware arrangements as they are developed.

Storage device 730 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read-only memory (ROM), and/or some combination of these devices.

The storage device 730 can include software services, servers, services, etc., that when the code that defines such software is executed by the processor 710, it causes the system to perform a function. In some embodiments, a hardware service that performs a particular function can include the software component stored in a computer-readable medium in connection with the necessary hardware components, such as processor 710, connection 705, output device 735, etc., to carry out the function.

For clarity of explanation, in some instances, the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program or a collection of programs that carry out a specific function. In some embodiments, a service can be considered a server. The memory can be a non-transitory computer-readable medium.

In some embodiments, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer-readable media. Such instructions can comprise, for example, instructions and data which cause or otherwise configure a general purpose computer, special purpose computer, or special purpose processing device to perform a certain function or group of functions. Portions of computer resources used can be accessible over a network. The executable computer instructions may be, for example, binaries, intermediate format instructions such as assembly language, firmware, or source code. Examples of computer-readable media that may be used to store instructions, information used, and/or information created during methods according to described examples include magnetic or optical disks, solid-state memory devices, flash memory. USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

What is claimed is:

1. A method comprising:
creating a first routing table at each of a plurality of provider edge nodes in a first data center, the first routing table including a first sequence number for a host connected to one of the plurality of provider edge nodes, the first sequence number being used to track intra-data center movement of the host within the first data center;
creating a second routing table at a corresponding gateway of each of a plurality of data centers, the plurality of data centers including the first data center, the second routing table including the first sequence number for the host and a second sequence number for the host, the second sequence number being used to track inter-data center movement of the host between the plurality of data centers; and
updating one of (1) the first sequence number in the first routing table when the host makes an intra-data center move from a first provider edge node to a second provider edge node in the first data center, or (2) the second sequence number in the second routing table when the host makes an inter-data center move from the first data center to a second data center of the plurality of data centers.

2. The method of claim 1, further comprising:
receiving an indication of the intra-data center movement of the host when a second provider edge node in the first data center advertises a Media Access Control (MAC) address of the host.

3. The method of claim 2, further comprising:
updating the first sequence number in the second routing table at the corresponding gateway of the second data center.

4. The method of claim 1, further comprising:
receiving an indication of the inter-data center movement of the host when the corresponding gateway of the second data center receives a Media Access Control (MAC) address of the host from a provide edge node in the second data center.

5. The method of claim 4, further comprising:
updating the second sequence number in the second routing table at the corresponding gateway of the second data center;
advertising the MAC address of the host to the corresponding gateway of remaining data centers of the plurality of data centers.

6. The method of claim 5, further comprising:
removing, from the second routing table at the corresponding gateway of the first data center, previously advertised MAC address of the host; and
incrementing, at the corresponding gateway of the first data center, the first sequence number for the host.

7. The method of claim 6, wherein
the corresponding gateway of the first data center advertises a message to the plurality of provider edge nodes in the first data center, the message including the first sequence number incremented and an Unknown MAC Route (UMR) flag set to one, and
each of the plurality of provider edge nodes in the first data center delete the MAC address of the host from a respective local MAC-Virtual Routing and Forwarding (VRF) table.

8. A network controller comprising:
one or more memories having computer-readable instructions stored therein; and
one or more processors configured to execute the computer-readable instructions to:
create a first routing table at each of a plurality of provider edge nodes in a first data center, the first routing table including a first sequence number for a host connected to one of the plurality of provider edge nodes, the first sequence number being used to track intra-data center movement of the host within the first data center;
create a second routing table at a corresponding gateway of each of a plurality of data centers, the plurality of data centers including the first data center, the second routing table including the first sequence number for the host and a second sequence number for the host, the second sequence number being used to track inter-data center movement of the host between the plurality of data centers; and
update one of (1) the first sequence number in the first routing table when the host makes an intra-data center move from a first provider edge node to a second provider edge node in the first data center, or (2) the second sequence number in the second routing table when the host makes an inter-data center move from the first data center to a second data center of the plurality of data centers.

9. The network controller of claim 8, wherein the one or more processors are further configured to receive an indication of the intra-data center movement of the host when a second provider edge node in the first data center advertises a Media Access Control (MAC) address of the host.

10. The network controller of claim 9, wherein the one or more processors are further configured to update the first sequence number in the second routing table at the corresponding gateway of the second data center.

11. The network controller of claim 8, wherein the one or more processors are further configured to receive an indication of the inter-data center movement of the host when the corresponding gateway of the second data center receives a Media Access Control (MAC) address of the host from a provide edge node in the second data center.

12. The network controller of claim 11, wherein the one or more processors are further configured to:
update the second sequence number in the second routing table at the corresponding gateway of the second data center;
advertise the MAC address of the host to the corresponding gateway of remaining data centers of the plurality of data centers.

13. The network controller of claim 12, wherein the one or more processors are further configured to:
remove, from the second routing table at the corresponding gateway of the first data center, previously advertised MAC address of the host; and
increment, at the corresponding gateway of the first data center, the first sequence number for the host.

14. The network controller of claim 13, wherein
the corresponding gateway of the first data center advertises a message to the plurality of provider edge nodes in the first data center, the message including the first sequence number incremented and an Unknown MAC Route (UMR) flag set to one, and
each of the plurality of provider edge nodes in the first data center delete the MAC address of the host from a respective local MAC-Virtual Routing and Forwarding (VRF) table.

15. One or more non-transitory computer-readable media comprising computer-readable instructions, which when executed by one or more processors of a network controller of an interconnected network, cause the network controller to:
create a first routing table at each of a plurality of provider edge nodes in a first data center, the first routing table including a first sequence number for a host connected to one of the plurality of provider edge nodes, the first sequence number being used to track intra-data center movement of the host within the first data center;
create a second routing table at a corresponding gateway of each of a plurality of data centers, the plurality of data centers including the first data center, the second routing table including the first sequence number for the host and a second sequence number for the host, the second sequence number being used to track inter-data center movement of the host between the plurality of data centers; and
update one of (1) the first sequence number in the first routing table when the host makes an intra-data center move from a first provider edge node to a second provider edge node in the first data center, or (2) the second sequence number in the second routing table when the host makes an inter-data center move from the first data center to a second data center of the plurality of data centers.

16. The one or more non-transitory computer-readable media of claim 15, wherein the execution of the computer-readable instructions cause the network controller to receive an indication of the intra-data center movement of the host when a second provider edge node in the first data center advertises a Media Access Control (MAC) address of the host.

17. The one or more non-transitory computer-readable media of claim 16, wherein the execution of the computer-readable instructions cause the network controller to update the first sequence number in the second routing table at the corresponding gateway of the second data center.

18. The one or more non-transitory computer-readable media of claim 15, wherein the execution of the computer-readable instructions cause the network controller to receive an indication of the inter-data center movement of the host when the corresponding gateway of the second data center receives a Media Access Control (MAC) address of the host from a provide edge node in the second data center.

19. The one or more non-transitory computer-readable media of claim 18, wherein the execution of the computer-readable instructions cause the network controller to:
update the second sequence number in the second routing table at the corresponding gateway of the second data center;
advertise the MAC address of the host to the corresponding gateway of remaining data centers of the plurality of data centers.

20. The one or more non-transitory computer-readable media of claim 19, wherein the execution of the computer-readable instructions cause the network controller to:
remove, from the second routing table at the corresponding gateway of the first data center, previously advertised MAC address of the host; and
increment, at the corresponding gateway of the first data center, the first sequence number for the host.
